(19) United States
(12) Patent Application Publication
(10) Pub. No.: US 2026/0368154 A1
(43) Pub. Date: Nov. 19, 2026

(54) SYSTEM AND METHOD FOR CANONICALIZATION INFRASTRUCTURE, PROVENANCE LOCKING, AND REFERENCE AUTHORITY RESOLUTION

(71) Applicant: Fieldstone Holdings, Inc., Pasadena, CA (US)

(72) Inventor: Shyla Stewart, Pasadena, CA (US)

(73) Assignee: Fieldstone Holdings, Inc., Pasadena, CA (US)

(21) Appl. No.: 19/661,564

(22) Filed: Apr. 28, 2026

Related U.S. Application Data
(60) Provisional application No. 63/835,070, filed on May 15, 2025.

(51) Int. Cl. G06F 16/23

(52) U.S. Cl. CPC G06F 16/2365

(57) ABSTRACT

A software framework and infrastructure known as ATLAS(Assimilation of Taxonomic data for Leverage via Automation and Scale), for the ingestion, adjudication, and publication of authoritative digital content. The system utilizes a four-layer architecture to transform probabilistic candidate assertions into deterministic canonical truth. An acquisition layer ingests raw data artifacts from authoritative sources, assigning immutable ingestion identifiers and maintaining a chain of custody. An extraction layer utilizes structural extraction and optical character recognition (OCR) to generate candidate attributes held in a staging schema. A canonical resolution engine serves as a singular control point, executing a deterministic adjudication process and conflict resolution logic to map candidate attributes to a unified taxonomic schema. The system enforces provenance locking and metadata integrity, providing a grounding layer for artificial intelligence (AI) systems to mitigate data hallucination and ensure reference authority.

### CROSS-REFERENCE TO RELATED APPLICATIONS

This application claims the benefit of priority to U.S. Provisional Patent Application No. 63/835,070, filed May 15, 2025, the entire disclosure of which is hereby incorporated by reference.

### STATEMENT REGARDING FEDERALLY SPONSORED RESEARCH OR DEVELOPMENT

Not applicable.

### BACKGROUND OF THE INVENTION

The proliferation of large-scale language models and artificial intelligence inference engines has created a critical demand for verifiable, grounded data. Current systems often rely on unstructured or semi-structured data acquisition (e.g., "web-scraping"), which lacks a deterministic chain of custody and provenance. This results in "hallucinations," where generative models produce factually incorrect outputs due to the absence of a canonical reference point. Existing content management systems are generally designed for internal workflows rather than providing a gated, immutable infrastructure for external reference authority. There exists a need for a canonicalization infrastructure that isolates probabilistic extraction from deterministic resolution to ensure the integrity of multi-vertical knowledge content.

### BRIEF SUMMARY OF THE INVENTION

The invention is a canonicalization infrastructure that solves the technical problem of data hallucination and provenance loss in AI environments. The system implements a gated, four-layer architecture that structurally isolates probabilistic data extraction from deterministic data resolution. By utilizing a canonical resolution engine as a singular control point, the infrastructure adjudicates competing assertions into a unified taxonomic schema. The resulting provenance lock ensures that every canonical identifier is logically tied to an immutable source artifact via a source-of-truth hash, providing a verifiable grounding layer for external computing environments.

### BRIEF DESCRIPTION OF THE DRAWINGS

FIG. 1 is a block diagram illustrating the overall system architecture of the canonicalization infrastructure, depicting the flow from raw data artifacts through taxonomic tagging to a dynamic filter-UX engine.

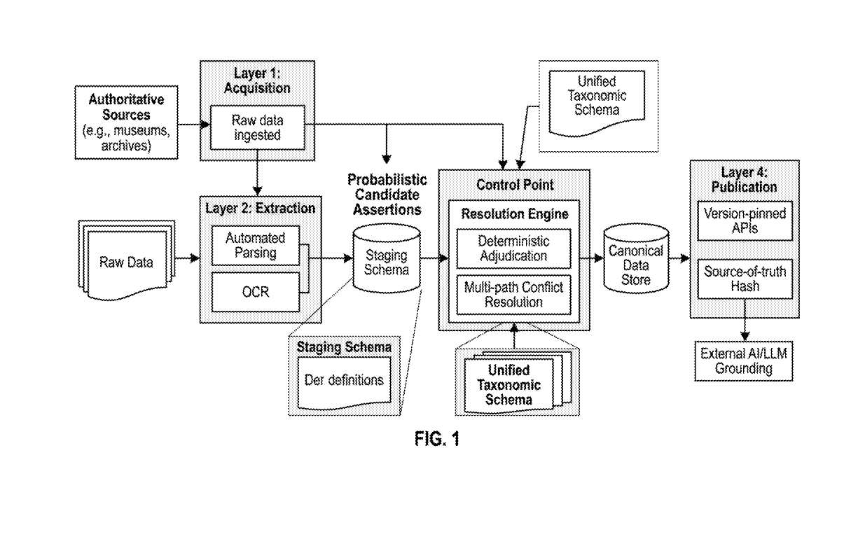

FIG. 2 is a functional architectural diagram depicting the four-layer control-point system, illustrating the transition of data from authoritative source acquisition to Layer 3 canonical resolution.

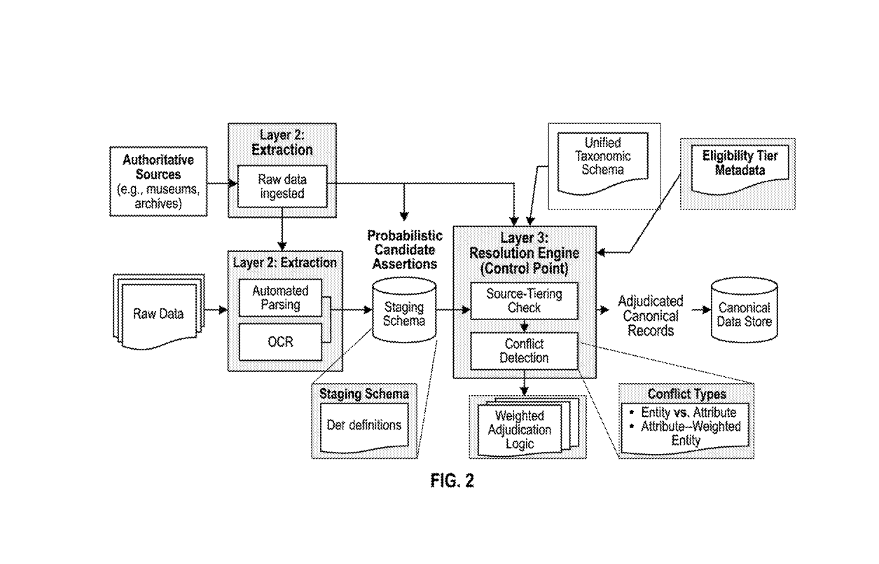

### DETAILED DESCRIPTION OF THE INVENTION

The invention (referred to herein as the ATLASsystem, an acronym for Assimilation of Taxonomic data for Leverage via Automation and Scale) implements a strictly gated architecture where reference authority is decoupled from content ingestion

As used herein, “canonicalization infrastructure” refers to a multi-layered hardware and software environment configured to reconcile disparate data inputs into a singular, immutable source of truth that preserves lineage and metadata integrity across arbitrary subject domains.

The term “deterministic grounding layer” refers to a technical interface through which an external computing environment (such as an LLM or AI engine) can retrieve canonical identifiers that are logically locked to an original authoritative source artifact. This layer 'grounds' the external environment by providing a verifiable reference point that prevents the propagation of non-authoritative or hallucinated data

In one embodiment, the system comprises a four-layer control-point architecture, each layer performing a distinct function in the canonicalization process. The four layers are described in turn below.
Layer 1, the acquisition layer, collects eligible sources (e.g., API connectors, secure S3 file drops). Original artifacts are treated as immutable, and the system assigns a unique Ingestion Event ID and checksum to each artifact.
Layer 2, the extraction layer, utilizes probabilistic extraction logic to convert raw sources into candidate assertions. In one embodiment, the system employs automated document parsing modules and tabular data extraction engines to identify structured data within unstructured files. For image-based artifacts, the system utilizes optical character recognition (OCR) modules to generate searchable text. All outputs are stored in a staging schema isolated from the canonical data store.
Layer 3, the resolution layer, is the singular control point, which adjudicates reference truth by disambiguating entities and aligning them with a unified taxonomic schema comprising dimensions selected from a group consisting of: color, material, era, region, geospatial data, temporal markers, technical specifications, and other domain-specific metadata identifiers.
   Layer 3 implements a multi-path conflict resolution logic to handle contradictory assertions from multiple authoritative sources: (a) tiered heuristics, whereinthe system prioritizes assertions from a first tier of reference-grade institutions (Tier 1) over a second tier of conditionally eligible sources (Tier 2); (b) weighted adjudication, wherein the system calculates a reliability vector based on extraction method and metadata recency; and (c) an HITL dashboard wherein high-entropy data conflicts are routed to a human-in-the-loop interface that displays the conflicting assertions alongside the original Layer 1 source artifact for manual arbitration.
Layer 4, the publication layer, provides read-only, version-pinned APIs. This layer acts as a reference intelligence infrastructure for external AI labs, preventing training-loop coupling.

The system creates an immutable provenance lock between a canonical identifier and its source lineage. Metadata includes administrative (rights/licenses), descriptive (taxonomic attributes), and process (extraction logs) metadata, ensuring a source-of-truth hash is available for downstream AI verification.

What is claimed is:

1. A system for maintaining canonical reference authority for multi-vertical knowledge content, the system comprising:
an acquisition module configured to ingest a plurality of raw data artifacts from authoritative sources and assign each artifact an immutable ingestion event identifier;
an extraction module configured to process the raw data artifacts using probabilistic extraction logic to generate a set of candidate assertions stored in a staging schema isolated from a canonical data store;
a canonical resolution engine configured to serve as a singular control point for data authority, the engine executing a deterministic adjudication process and conflict resolution logic to transform candidate assertions into canonical identifiers based on a unified taxonomic schema; anda publication interface configured to provide read-only access to the canonical identifiers and a source-of-truth hash to downstream computing environments, enabling verification of downstream AI outputs against the immutable ingestion event identifier.

2. The system of claim 1, wherein the extraction module is configured to identify candidate attributes comprising at least one taxonomic dimension selected from the group consisting of: color, material, era, region, geospatial data, temporal markers, and technical specifications.

3. The system of claim 1, wherein the deterministic adjudication process of the resolution engine requires a source-eligibility validation prior to canonicalization, categorizing sources into a plurality of tiers based on a metadata audit of chain-of-title.

4. The system of claim 1, wherein the publication interface provides a source-of-truth hash for each canonical identifier, enabling a downstream Large Language Model (LLM) to verify generated outputs against the immutable ingestion event identifier.

5. The system of claim 1, wherein the resolution engine maintains a versioned change log for every canonical identifier, treating data corrections as first-class state changes within the canonical data store.

6. The system of claim 1, wherein the canonicalization infrastructure provides an API-accessible deterministic grounding layer configured to supply the source-of-truth hash to an artificial intelligence (AI) inference engine to validate the veracity of generated outputs.
